(19) United States
(12) Patent Application Publication
(10) Pub. No.: US 2022/0063090 A1
(43) Pub. Date: Mar. 3, 2022

(54) ADJUSTMENT METHOD FOR OPERATION PARAMETERS AND ROBOT SYSTEM

(71) Applicant: SEIKO EPSON CORPORATION, Tokyo (JP)

(72) Inventor: Ryutaro SEKI, SHIOJIRI-SHI (JP)

(21) Appl. No.: 17/412,294

(22) Filed: Aug. 26, 2021

(30) Foreign Application Priority Data
Aug. 28, 2020 (JP) 2020-144245

(51) Int. Cl. B25J 9/16; B25J 19/02; B25J 5/00

(52) U.S. Cl. CPC B25J 9/163; B25J 5/007; B25J 19/02

(57) ABSTRACT

An adjustment method includes (a) causing a robot to execute an adjustment operation using candidate values of operation parameters and acquiring a measurement result of a sensor, (b) updating the candidate values of the operation parameters by executing optimization processing for the operation parameters using the measurement result, and (c) determining adjustment values of the operation parameters by repeating (a) and (b) until the optimization processing converges.

The present application is based on, and claims priority from JP Application Serial Number 2020-144245, filed Aug. 28, 2020, the disclosure of which is hereby incorporated by reference herein in its entirety.

### BACKGROUND

### 1. Technical Field

The present disclosure relates to an adjustment method for operation parameters and a robot system.

### 2. Related Art

JP-A-2018-118353 (Patent Literature 1) describes a control system that, in order to reduce vibration of a robot, causes the robot to operate, detects an overshoot amount, and performs learning control for the robot based on the overshoot amount.

However, in a site where the robot performs work, the robot cannot sufficiently execute the work unless operation parameters of a robot system are set considering vibration of a stand on which the robot is set and a peripheral device such as a camera in addition to the vibration of the robot.

### SUMMARY

According to a first aspect of the present disclosure, there is provided an adjustment method for adjusting operation parameters of a robot system including a robot, a stand on which the robot is set, and a sensor capable of detecting vibration of the stand or vibration of a peripheral device provided on the stand. The adjustment method includes: (a) causing the robot to execute an adjustment operation using candidate values of the operation parameters and acquiring a measurement result of the sensor during the adjustment operation; (b) updating the candidate values of the operation parameters by executing optimization processing for the operation parameters using the measurement result; and (c) determining adjustment values of the operation parameters by repeating (a) and (b) until the optimization processing converges.

According to a second aspect of the present disclosure, a robot system is provided. The robot system includes: a robot; a stand on which the robot is set; a sensor capable of detecting vibration of the stand or vibration of a peripheral device provided on the stand; and a control section configured to control the robot. The control section executes: (a) processing for causing the robot to execute an adjustment operation using candidate values of operation parameters of the robot system and acquiring a measurement result of the sensor during the adjustment operation; (b) processing for updating the candidate values of the operation parameters by executing optimization processing for the operation parameters using the measurement result; and (c) processing for determining adjustment values of the operation parameters by repeating the processing (a) and the processing (b) until the optimization processing converges.

### BRIEF DESCRIPTION OF THE DRAWINGS

FIG. 1 is an explanatory diagram of a configuration example of a robot system in a first embodiment.

FIG. 2 is a functional block diagram of an information processing device.

FIG. 3 is a flowchart showing an adjustment procedure for operation parameters.

FIG. 4 is a flowchart showing a procedure of search processing for the operation parameters.

FIG. 5 is an explanatory diagram showing an example of a measurement result of a sensor during an adjustment operation.

FIG. 6 is an explanatory diagram of a configuration example of a robot system in a second embodiment.

### DESCRIPTION OF EXEMPLARY EMBODIMENTS

### A. First Embodiment

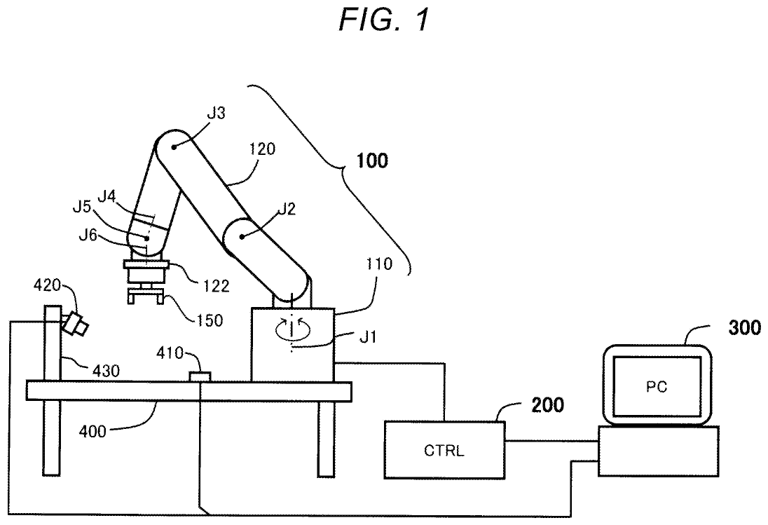

FIG. 1 is an explanatory diagram showing an example of a robot system in a first embodiment. The robot system includes a robot 100, a control device 200 that controls the robot 100, an information processing device 300, and a stand 400 on which the robot 100 is set. The information processing device 300 is, for example, a personal computer.

On the stand 400, besides the robot 100, a sensor 410 capable of detecting vibration of the stand 400 and a peripheral device 420 are provided. The peripheral device 420 is, for example, a camera for configuring a vision system. In the example shown in FIG. 1, the peripheral device 420 is set on a column 430 of the stand 400. However, in most cases, the peripheral device 420 is set in a state in which the vibration of the stand 400 is transmitted to the peripheral device 420. In the present disclosure, a setting state in which the vibration of the stand 400 is transmitted to the peripheral device 420 is included in the wording “the peripheral device 420 is provided in the stand 400”.

The robot 100 includes a base 110 and an arm 120. The arm 120 is sequentially coupled by six joints. An end effector 150 is attached to an arm end 122, which is the distal end portion of the arm 120.

The arm 120 is sequentially coupled by six joints J1 to J6. Among the joints J1 to J6, three joints J2, J3, and J5 are bending joints and the other three joints J1, J4, and J6 are twisting joints. A six-axis robot is illustrated in this embodiment. However, a robot including any arm mechanism including one or more joints can be used. The robot 100 in this embodiment is a vertical articulated robot. However, a horizontal articulated robot may be used.

The sensor 410 is a sensor capable of detecting vibration of the stand 400. In general, vibration can be detected by measuring a time-series change in any one of a position, speed, and acceleration. As the sensor 410, for example, a position sensor, a gyro sensor, an acceleration sensor, or an inertial measurement unit can be used. The sensor 410 may be set in the peripheral device 420 to be able to detect vibration the peripheral device 420.

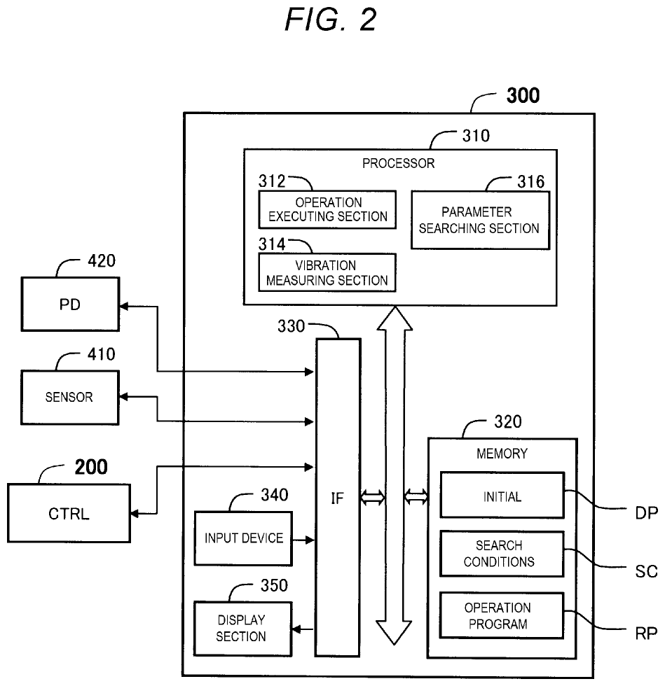

FIG. 2 is a block diagram showing functions of the information processing device 300. The information processing device 300 includes a processor 310, a memory 320, an interface circuit 330, and an input device 340 and a display section 350 coupled to the interface circuit 330. The sensor 410, the peripheral device 420, and the control device 200 are further coupled to the interface circuit 330.

The processor 310 executes functions of an operation executing section 312 that causes the robot 100 to execute operation, a vibration measuring section 314 that acquires vibration as a measurement result of the sensor 410 during the operation of the robot 100, and a parameter searching section 316 that searches for operation parameters of the robot system using the measurement result of the sensor 410. The sections 312, 314, and 316 are realized by the processor 310 executing a computer program stored in the memory 320. However, a part or all of the sections 312, 314, and 316 may be realize by a hardware circuit. The processor 310 is equivalent to the “control section” of the present disclosure.

Initial parameters DP, search conditions SC, and an operation program RP are stored in the memory 320. The initial parameters DP are initial values of the operation parameters of the robot system. The search conditions SC are ranges of values of the operation parameters searched by optimization processing. The operation program RP is configured by a plurality of commands for causing the robot 100 to operate.

As the operation parameters of the robot system, for example, operation parameters of the robot 100 described below can be used.

### Examples of the Operation Parameters of the Robot

### (1) Maximum Acceleration of Axes

Maximum acceleration is acceleration set in axes of the robot 100 when an inertial moment of portions present further on the distal end side than the axes with respect to the axes is in a maximum state.

### (2) Acceleration Maximum Change Rate

An acceleration maximum change rate is a maximum change rate of acceleration allowed in the operation of the axes involving a change in the inertial moment. A change in the acceleration is limited to a lower value in a state in which the inertial moment is large

### (3) Weight Correction Coefficient

A weight correction coefficient is a coefficient for adjusting the acceleration in the operation of the axes according to a load weight of the robot 100.

As operation parameters to be adjusted in this embodiment, any operation parameters other than the above can be used.

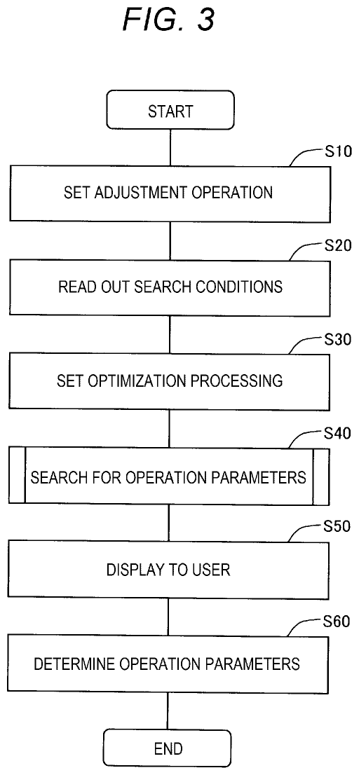

FIG. 3 is a flow chart showing an adjustment procedure for the operation parameters. This processing is executed by the processor 310 of the information processing device 300.

In step S10, an adjustment operation used to perform adjustment of the operation parameters of the robot system is set by a user. Specifically, the user creates an operation program RP for the adjustment operation and causes the operation executing section 312 to read the operation program RP, whereby the adjustment operation is set. In a typical example, the adjustment operation is operation used in specific work of the robot 100.

In step S20, the parameter searching section 316 reads out the search conditions SC from the memory 320, whereby the search conditions SC are set. As explained above, the search conditions SC are the ranges of the values of the operation parameters searched in the optimization processing.

In step S30, a method of the optimization processing is set by the user. In this embodiment, as index values used in the optimization processing, two index values, that is, an operation time of the robot 100 required for the adjustment operation and the magnitude of vibration caused by the adjustment operation are used. “An operation time of the robot 100” is a time from a start time until an end time of the adjustment operation. Usually, the operation time of the robot 100 and the magnitude of the vibration are in a tradeoff relation. Therefore, it is possible to obtain appropriate operation parameters by performing optimization of the operation parameters using the two index values.

As the optimization processing in which the two index values are used, various kinds of optimization processing described below can be used.

### Optimization Processing in Which an Objective Function and a Constrain Condition are Used

In this optimization processing, one of the two index values is set as an objective function and the other is set as a constraint condition.

### Optimization Processing in Which an Objective Function Including a Plurality of Index Values is Used

In this optimization processing, an objective function including both of the two index values is set. The optimization processing in which the objective function including the two index values is used is further divided into two kinds of optimization processing explained below.

### (1) Optimization Processing in Which Two Objective Functions are Used

This optimization processing is processing for respectively setting two index values as objective functions and using a multipurpose optimization algorithm to thereby perform optimization using two objective functions. As the multipurpose optimization algorithm, for example, a genetic algorithm and a desiring level method algorithm for calculating a Pareto optimum solution can be used.

### (2) Optimization Processing in Which a Single Objective Function Including the Two Index Values is Used

This optimization processing is processing for weighting and adding up the two index values to thereby set a single objective function and, then, performing normal optimization processing.

In this embodiment, among the kinds of optimization processing, the optimization processing in which the objective function and the constraint condition are used is used. In step S30, the operation time of the robot 100 required for the adjustment operation is set as the objective function and the magnitude of the vibration caused by the adjustment operation is set as the constraint condition. As an algorithm for the optimization processing, Bayes optimization is used. As the algorithm for the optimization processing, besides the Bayes optimization, various algorithms such as a grid search, a random search, a CMA-ES (Covariance Matrix Adaptation Evolution Strategy), and Nelder-Mead method can be used.

In step S40, the parameter searching section 316 executes a search for operation parameters according to the setting in steps S10 to S30.

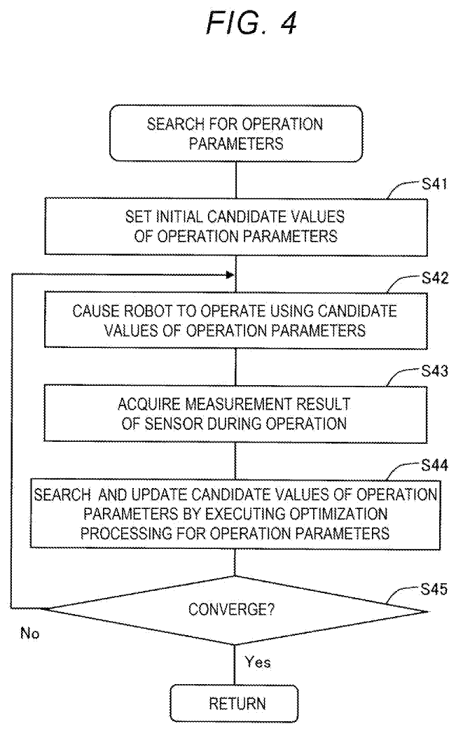

FIG. 4 is a flowchart showing a detailed procedure of the search processing for operation parameters in step S40 in FIG. 3. In step S41, the parameter searching section 316 reads out the initial parameters DP from the memory 320 and sets the initial parameters DP as initial candidate values of the operation parameters. In step S42, the operation executing section 312 causes the robot 100 to execute the adjustment operation using the candidate values of the operation parameters. In step S43, the vibration measuring section 314 acquires a measurement result of the sensor 410 during the adjustment operation.

In step S44, the parameter searching section 316 updates the candidate values of the operation parameters by executing the optimization processing for the operation parameters using the measurement result of the sensor 410. As explained above, in this embodiment, the operation time of the robot 100 required for the adjustment operation is set as the objective function and the magnitude of the vibration caused by the adjustment operation is set as the constraint condition. That is, under the constraint condition that the magnitude of the vibration caused by the adjustment operation is equal to or smaller than a predetermined threshold, the candidate values of the operation parameters are searched and updated such that the operation time of the robot 100 required for the adjustment operation is as short as possible.

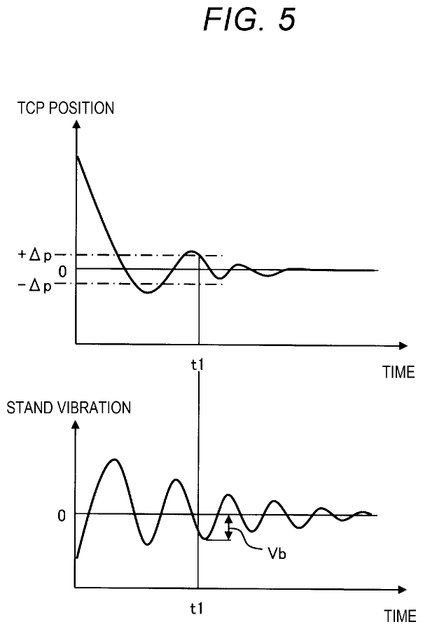

FIG. 5 is an explanatory diagram showing an example of the measurement result of the sensor 410 during the adjustment operation. An upper part of FIG. 5 shows a temporal change of a TCP (Tool Center Point) position of the robot 100. A lower part of FIG. 5 shows a temporal change of vibration of the stand 400 measured by the sensor 410. In a graph of the TCP position, a target position of a TCP is set to 0 and allowable position errors +Δp and −Δp are set above and below 0. The TCP position gradually approaches the target position. Time t1 when a position error of the TCP position finally becomes smaller than the allowable position errors +Δp and −Δp is determined as reaching time to the target position. A time from start time of the operation until the reaching time t1 is acquired as the operation time of the robot 100. The vibration of the stand 400 measured by the sensor 410 gradually decreases as the TCP approaches the target position. At this time, half amplitude Vb of the largest vibration after the reaching time t1 of the TCP to the target position is acquired as the magnitude of the vibration of the stand 400. In step S44 explained above, the optimization processing for the operation parameters is executed using the operation time of the robot 100 and the magnitude of the vibration acquired in this way.

When the search in step S40 in FIG. 3 converges, in step S50, a search result is displayed to the user. As a method for the display, for example, one of two methods described below can be adopted.

### Display Method 1

Among the operation parameters satisfying the constraint condition of the vibration of the stand 400 designated by the user, a set of operation parameters having the shortest operation time of the robot 100 is presented.

### Display Method 2

About a plurality of sets of operation parameters, a relation between the vibration of the stand 400 and the operation time of the robot 100 is presented. The user can select a set of operation parameters matching a request of the user most out of the plurality of sets of operation parameters.

In step S60, values after adjustment of the operation parameters are determined. This processing is executed by the user selecting the operation parameters displayed in step S50. Adjustment values of the operation parameters determined in this way are set in the operation program RP.

Step S50 explained above may be omitted. In this case, in step S60, a final set of operation parameters searched by the optimization processing is determined as the adjustment values of the operation parameters.

As explained above, in the first embodiment, the optimization processing for the operation parameters of the robot system is executed using the measurement result of the vibration of the stand 400 on which the robot 100 is set or the vibration of the peripheral device 420 provided on the stand 400. Therefore, the operation parameters can be adjusted to reduce the vibration of the stand 400 and the peripheral device 420.

In the first embodiment, the two index values, that is, the operation time of the robot 100 and the magnitude of the vibration are used. However, the operation time of the robot 100 may not be used and only the magnitude of the vibration may be used as the index value of the optimization processing. For example, the optimization of the operation parameters may be performed within a predetermined search range of the operation parameters to minimize the magnitude of the vibration. However, it is preferable to use the two index values, that is, the operation time of the robot 100 and the magnitude of the vibration because the operation parameters can be optimized to reduce the operation time while reducing the magnitude of the vibration.

### B. Second Embodiment

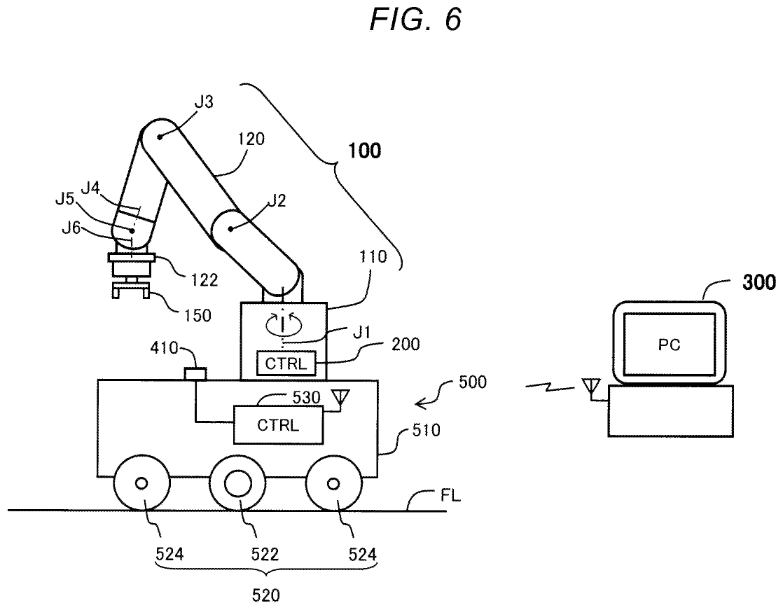

FIG. 6 is an explanatory diagram of a configuration example of a robot system in a second embodiment. A major difference from the first embodiment is that, in the second embodiment, the robot 100 is set on a carriage 500. The carriage 500 is also a type of the “stand” in the present disclosure. The control device 200 of the robot 100 is housed in the base 110.

The carriage 500 is configured as an autonomous mobile robot that autonomously travels on a floor surface FL. The carriage 500 includes a main body 510 and wheels 520 provided under the main body 510. The wheels 520 include two driving wheels 522 and four driven wheels 524. Half of the two driving wheels 522 and the four driven wheels 524 are drawn in FIG. 6. A control device 530 that controls the carriage 500 is provided in the main body 510.

The sensor 410 is set on the carriage 500. In the second embodiment, the sensor 410 is capable of detecting vibration of the carriage 500.

The control device 530 of the carriage 500 and the control device 200 of the robot 100 execute control of the robot system while communicating with each other. The control device 530 of the carriage 500 is capable of transmitting and receiving information to and from the information processing device 300 via wireless communication. A measurement result of the sensor 410 is supplied to the information processing device 300 via the control device 530 of the carriage 500.

An internal configuration and content of processing of the information processing device 300 in the second embodiment are substantially the same as the internal configuration and the content of the processing in the first embodiment. The second embodiment achieves substantially the same effects as the effects in the first embodiment.

However, in the second embodiment, the adjustment operation preferably includes the operation of the carriage 500 besides the operation of the robot 100. For example, one adjustment operation is preferably configured by a series of operation for, first, moving from a departure position to a destination position with the carriage 500 and stopping and, thereafter, executing operation for work with the robot 100. Consequently, it is possible to adjust operation parameters suitable for the adjustment operation including the operation of the carriage 500. In this case, the operation parameters to be adjusted may include not only the operation parameters of the robot 100 but also operation parameters of the carriage 500. As the operation parameters of the carriage 500, for example, maximum speed and maximum acceleration during movement can be used.

### Other Embodiments

The present disclosure is not limited to the embodiment explained above and can be realized in various aspects in a range not departing from the gist of the present disclosure. For example, the present disclosure can also be realized in aspects described below. Technical features in the embodiments corresponding to technical features in the aspects described below can be substituted or combined as appropriate in order to solve a part or all of the problems of the present disclosure or in order to achieve a part or all of the effects of the present disclosure. The technical features can be deleted as appropriate unless the technical features are explained as essential technical features in this specification.

(1) According to a first aspect of the present disclosure, there is provided an adjustment method for adjusting operation parameters of a robot system including a robot, a stand on which the robot is set, and a sensor capable of detecting vibration of the stand or vibration of a peripheral device provided on the stand. The adjustment method includes: (a) causing the robot to execute an adjustment operation using candidate values of the operation parameters and acquiring a measurement result of the sensor during the adjustment operation; (b) updating the candidate values of the operation parameters by executing optimization processing for the operation parameters using the measurement result; and (c) determining adjustment values of the operation parameters by repeating (a) and (b) until the optimization processing converges.

With the adjustment method, the optimization processing for the operation parameters of the robot system is executed using the measurement result of the vibration of the stand on which the robot is set or the vibration of the peripheral device set on the stand. Therefore, it is possible to adjust the operation parameters to reduce the vibration of the stand and the peripheral device.

(2) In the adjustment method, the optimization processing may be optimization in which one of an operation time of the robot required for the adjustment operation and magnitude of the vibration caused by the adjustment operation is set as an objective function and another is set as a constraint condition.

With the adjustment method, it is possible to adjust the operation parameters to reduce the operation time of the robot and the magnitude of the vibration of the stand or the peripheral device.

(3) In the adjustment method, the optimization processing may be optimization in which an objective function including two index values, that is, an operation time of the robot required for the adjustment operation and magnitude of the vibration caused by the adjustment operation is used.

With the adjustment method, it is possible to adjust the operation parameters to reduce the operation time of the robot and the magnitude of the vibration of the stand or the peripheral device.

(4) In the adjustment method, the stand may be a movable carriage, the adjustment operation may be operation including both of operation of the carriage and operation of the robot, and the operation parameters may include both of operation parameters of the carriage and operation parameters of the robot.

With the adjustment method, about the robot system including the robot set on the movable carriage, it is possible to adjust the operation parameters of the robot system including the operation parameters of the carriage and the operation parameters of the robot.

(5) According to a second aspect of the present disclosure, a robot system is provided. The robot system includes: a robot; a stand on which the robot is set; a sensor capable of detecting vibration of the stand or vibration of a peripheral device provided on the stand; and a control section configured to control the robot. The control section executes: (a) processing for causing the robot to execute an adjustment operation using candidate values of operation parameters of the robot system and acquiring a measurement result of the sensor during the adjustment operation; (b) processing for updating the candidate values of the operation parameters by executing optimization processing for the operation parameters using the measurement result; and (c) processing for determining adjustment values of the operation parameters by repeating the processing (a) and the processing (b) until the optimization processing converges.

With the robot system, the optimization processing for the operation parameters of the robot system is executed using the measurement result of the vibration of the stand on which the robot is set or the vibration of the peripheral device set on the stand. Therefore, it is possible to adjust the operation parameters to reduce the vibration of the stand and the peripheral device.

The present disclosure can be realized in various aspects other than the above. The present disclosure can be realized in aspects such as a robot system including a robot and a robot control device, a computer program for realizing a function of the robot control device, and a non-transitory storage medium recording the computer program.

What is claimed is:

1. An adjustment method for adjusting operation parameters of a robot system including a robot, a stand on which the robot is set, and a sensor capable of detecting vibration of the stand or vibration of a peripheral device provided on the stand,
the adjustment method comprising:
(a) causing the robot to execute an adjustment operation using candidate values of the operation parameters and acquiring a measurement result of the sensor during the adjustment operation;
(b) updating the candidate values of the operation parameters by executing optimization processing for the operation parameters using the measurement result; and
(c) determining adjustment values of the operation parameters by repeating (a) and (b) until the optimization processing converges.

2. The adjustment method according to claim 1, wherein the optimization processing is optimization in which one of an operation time of the robot required for the adjustment operation and magnitude of the vibration caused by the adjustment operation is set as an objective function and another is set as a constraint condition.

3. The adjustment method according to claim 1, wherein the optimization processing is optimization in which an objective function including two index values, that is, an operation time of the robot required for the adjustment operation and magnitude of the vibration caused by the adjustment operation is used.

4. The adjustment method according to claim 1, wherein
the stand is a movable carriage,
the adjustment operation is operation including both of operation of the carriage and operation of the robot, and
the operation parameters include both of operation parameters of the carriage and operation parameters of the robot.

5. A robot system comprising:
a robot;
a stand on which the robot is set;
a sensor capable of detecting vibration of the stand or vibration of a peripheral device provided on the stand; and
a control section configured to control the robot, wherein the control section executes:
(a) processing for causing the robot to execute an adjustment operation using candidate values of operation parameters of the robot system and acquiring a measurement result of the sensor during the adjustment operation;
(b) processing for updating the candidate values of the operation parameters by executing optimization processing for the operation parameters using the measurement result; and
(c) processing for determining adjustment values of the operation parameters by repeating the processing (a) and the processing (b) until the optimization processing converges.
